(19) United States
(12) Patent Application Publication
(10) Pub. No.: US 2016/0026065 A1
(43) Pub. Date: Jan. 28, 2016

(54) LIGHT CONVERSION MEMBER, METHOD OF MANUFACTURING THE SAME, AND DISPLAY APPARATUS HAVING THE SAME

(71) Applicant: SAMSUNG DISPLAY CO., LTD., Yongin-City (KR)

(72) Inventors: Seung Hwan BAEK, Seoul (KR); Yeongbae LEE, Suwon-si (KR); Seokhyun NAM, Seoul (KR)

(21) Appl. No.: 14/680,304

(22) Filed: Apr. 7, 2015

(30) Foreign Application Priority Data
Jul. 23, 2014 (KR) 10-2014-0093342

(51) Int. Cl. G02F 1/35; F21V 8/00; G02F 1/1335

(52) U.S. Cl. CPC G02F 1/353; G02F 1/133504; G02B 6/0011

(57) ABSTRACT

A light conversion member includes a first unit substrate, a second unit substrate disposed to face the first unit substrate, a quantum-dot accommodating member disposed between the first and second unit substrates and positioned adjacent to a boundary of the first and second unit substrates to seal a space between the first and second unit substrates, and a quantum dot member in the sealed space to convert a light incident thereto to a white light.

### CROSS-REFERENCE TO RELATED APPLICATION

Korean Patent Application No. 10-2014-0093342, filed on Jul. 23, 2014, in the

Korean Intellectual Property Office, and entitled: “Light Conversion Member, Method of Manufacturing the Same, and Display Apparatus Having the Same,” is incorporated by reference herein in its entirety.

### BACKGROUND

1. Field

The present disclosure relates to a light conversion member, a method of manufacturing the light conversion member, and a display apparatus having the light conversion member.

2. Description of the Related Art

A liquid crystal display may include a display panel including pixels to display an image and a backlight unit supplying light to the display panel. The pixels of the display panel may control a transmittance of the light from the backlight unit to display the image.

### SUMMARY

Embodiments may be realized by providing a method of manufacturing a light conversion member, the method including forming a plurality of first grooves extending in a first direction on a lower surface of a first mother substrate and a plurality of second grooves extending in a second direction orthogonal to the first direction on the lower surface of the first mother substrate; forming a plurality of third grooves extending in the first direction on an upper surface of a second mother substrate and a plurality of fourth grooves extending in the second direction on the upper surface of the second mother substrate; forming first quantum-dot accommodating members on an upper surface of the first mother substrate to have a rectangular closed-loop shape, the first quantum-dot accommodating members being in first unit areas defined by the first and second grooves; forming second quantum-dot accommodating members on a lower surface of the second mother substrate to have a rectangular closed-loop shape, the second quantum-dot accommodating members being in second unit areas defined by the third and fourth grooves; forming a quantum dot member in the first and second quantum-dot accommodating members; coupling the first mother substrate and the second mother substrate such that the upper surface of the first mother substrate faces the lower surface of the second mother substrate; connecting the first and second quantum-dot accommodating members; and separating the first and second mother substrates along the first to fourth grooves to form light conversion members.

The first and third grooves may be arranged in the second direction at regular intervals, the second grooves may be adjacent to both ends of the first mother substrate in the first direction, and the fourth grooves may be adjacent to both ends of the second mother substrate in the first direction.

Each of the first and second mother substrates may have a thickness of about 0.5 mm and the first to fourth grooves may have a same width and a depth of about 200 micrometers.

The first and second mother substrates may include glass, the first and second quantum-dot accommodating members may include a fit glass, and forming the first and second quantum-dot accommodating members may include drying and sintering a fit paste.

The first quantum-dot accommodating members may have a melting point, a durability, and a coupling force, which are respectively higher than a melting point, a durability, and a coupling force of the second quantum-dot accommodating members.

The first and second quantum-dot accommodating members may have a same width, the first quantum-dot accommodating members may have a first thickness, and the second quantum-dot accommodating members may have a second thickness smaller than the first thickness.

The first thickness may be in a range from about 300 micrometers to about 350 micrometers and the second thickness may be in a range from about 10 micrometers to about 15 micrometers.

Forming the quantum dot member may include filling the first and second quantum-dot accommodating members with a quantum dot resin including a resin and quantum dots distributed in the resin; and curing the quantum dot resin to form the quantum dot member, the quantum dot member having a height corresponding to an upper surface of the first quantum-dot accommodating members and a lower surface of the second quantum-dot accommodating members.

Coupling the first and second mother substrates may include disposing a sealant on the upper surface of the first mother substrate to surround the first unit areas; and coupling the first and second mother substrates using the sealant after disposing the first and second mother substrates such that the upper surface of the first mother substrate faces the lower surface of the second mother substrate, the first grooves overlap with the third grooves, the second grooves overlap with the fourth grooves, and the first quantum-dot accommodating members overlap with the second quantum-dot accommodating members.

Connecting the first and second quantum-dot accommodating members may include irradiating the second quantum-dot accommodating members from above the upper surface of the second substrate to connect the second quantum-dot accommodating members and the first quantum-dot accommodating members, and the second quantum-dot accommodating members may be cured by irradiating.

Irradiating may be performed using a laser beam having a wavelength of about 770 nm and a power of about 5 W to about 8 W.

Forming the light conversion members may include irradiating the first to fourth grooves to cut the first and second mother substrates along the first to fourth grooves.

Irradiating may be performed using a laser beam output from a CO₂ laser.

A width between an inner surface of each of the first and second quantum-dot accommodating members adjacent to the quantum dot member and each side surface of first and second unit substrates formed by cutting the first and second mother substrates may be equal to or smaller than about 1.5 mm.

Embodiments may be realized by providing a light conversion member, including a first unit substrate; a second unit substrate facing the first unit substrate; a quantum-dot accommodating member between the first and second unit substrates and adjacent to a boundary of the first and second unit substrates, the quantum-dot accommodating member forming a sealed space between the first and second unit substrates; and a quantum dot member in the sealed space, the quantum dot member converting light incident thereon to white light.

The first and second unit substrates each may include glass and the quantum-dot accommodating member may include a fit glass.

Each of the first and second unit substrates may have a thickness of about 0.5 mm and the quantum-dot accommodating member may have a thickness of about 310 micrometers to about 365 micrometers.

A width between an inner surface of the quantum-dot accommodating member adjacent to the quantum dot member and each side surface of the first and second unit substrates may be equal to or smaller than about 1.5 mm.

Embodiments may be realized by providing a display apparatus, including a display panel; a light source that generates a first light; a light conversion member that converts the first light to a second light; a light guide plate that guides the second light towards the display panel; an optical sheet that receives the second light from the light guide plate, the optical sheet diffusing and condensing the second light towards the display panel; and the display panel displaying an image using the second light, the light source being adjacent to one side of the light guide plate, the light conversion member being between the light source and the light guide plate, the light conversion member including a first unit substrate; a second unit substrate facing the first unit substrate; a quantum-dot accommodating member between the first and second unit substrates and adjacent to a boundary of the first and second unit substrates, the quantum-dot accommodating member forming a sealed space between the first and second unit substrates; and a quantum dot member in the sealed space, the quantum dot member converting light incident thereon to white light, the first and second unit substrates including glass, and the quantum-dot accommodating member including a fit glass.

Each of the first and second unit substrates may have a thickness of about 0.5 mm, the quantum-dot accommodating member may have a thickness of about 310 micrometers to about 365 micrometers, and a width between an inner surface of the quantum-dot accommodating member adjacent to the quantum dot member and each side surface of the first and second unit substrates may be equal to or smaller than about 1.5 mm.

### BRIEF DESCRIPTION OF THE DRAWINGS

Features will become apparent to those of skill in the art by describing in detail exemplary embodiments with reference to the attached drawings in which:

FIGS. 1A to 1O illustrate views of a method of manufacturing a light conversion member according to an exemplary embodiment;

FIG. 2 illustrates a perspective view of a light conversion member manufactured by a manufacturing method according to an exemplary embodiment;

FIG. 3 illustrates a cross-sectional view taken along line VI-VP shown in FIG. 2;

FIG. 4 illustrates an upper plan view of a display apparatus employing a light conversion member according to an exemplary embodiment; and

FIG. 5 illustrates a side view of a display apparatus employing a light conversion member according to an exemplary embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present.

Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

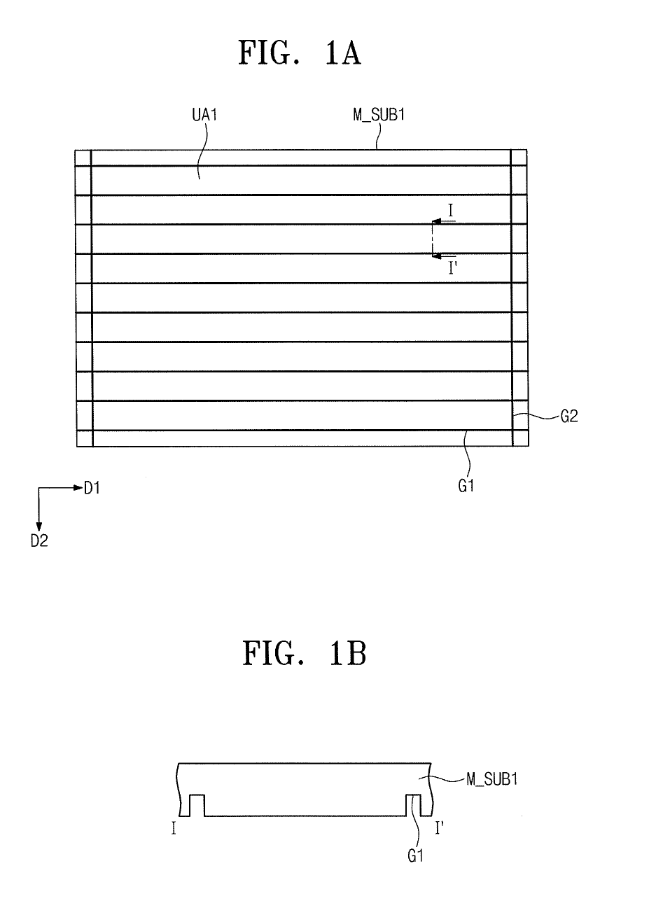

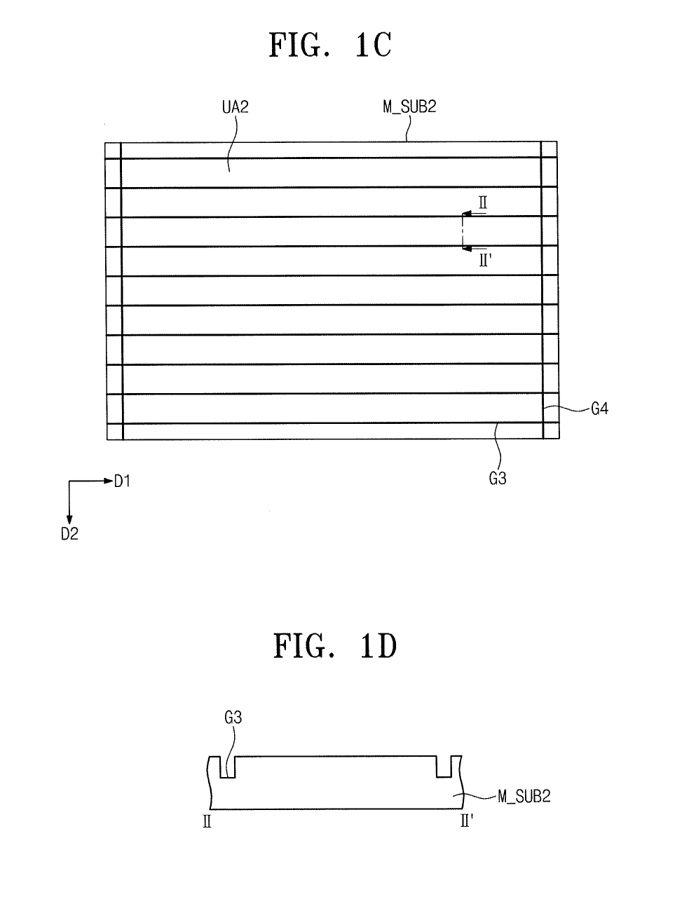

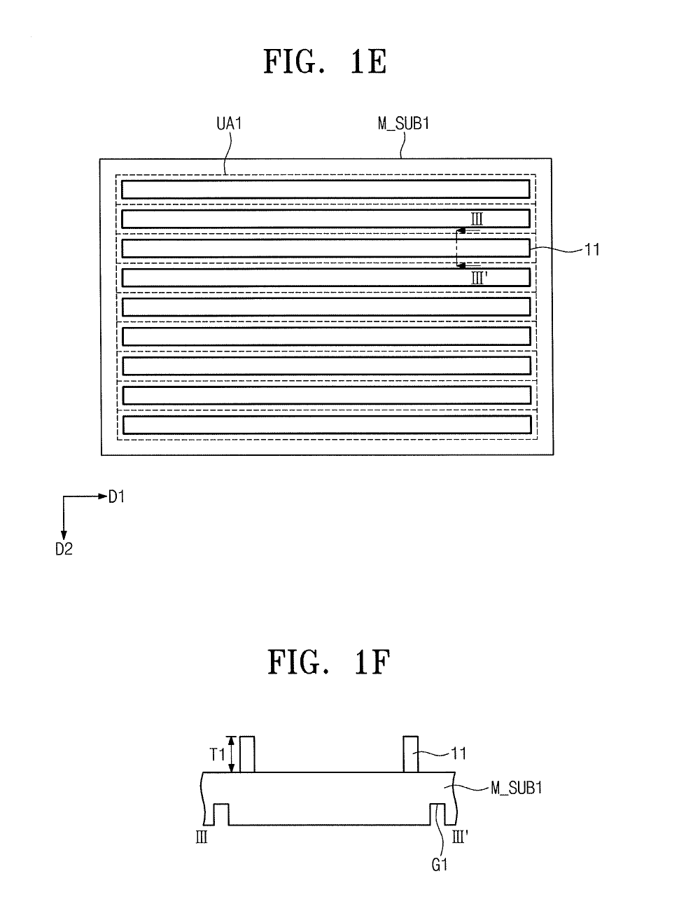

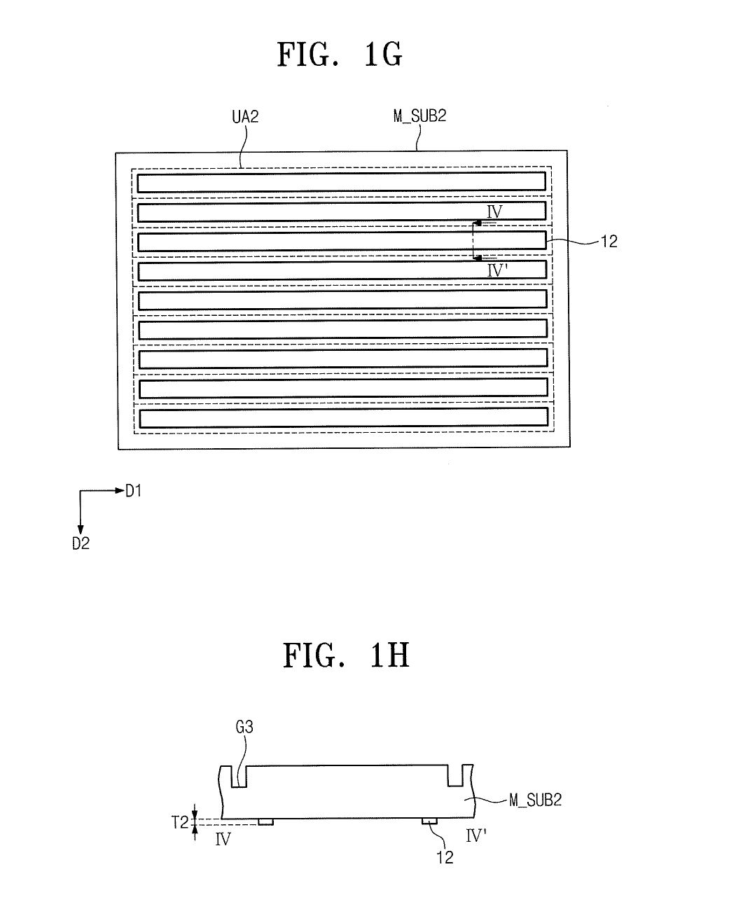

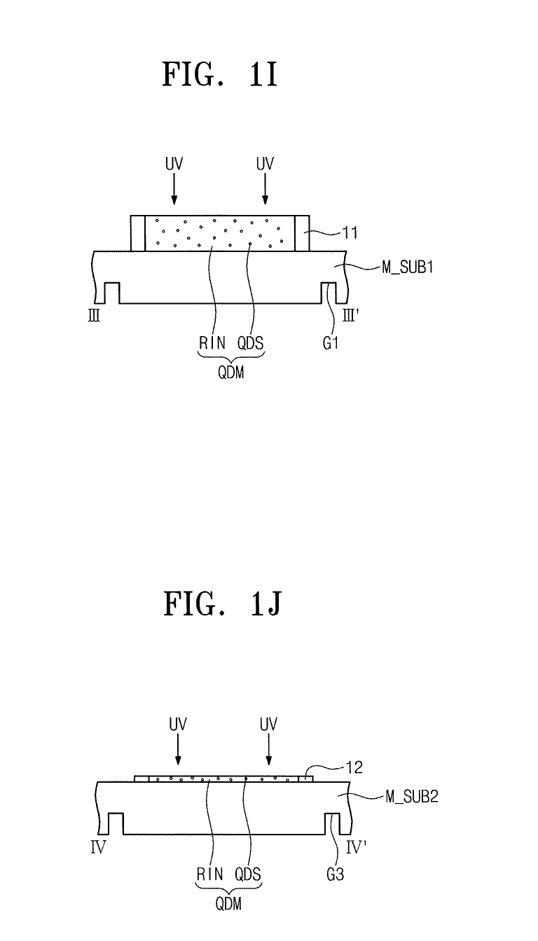

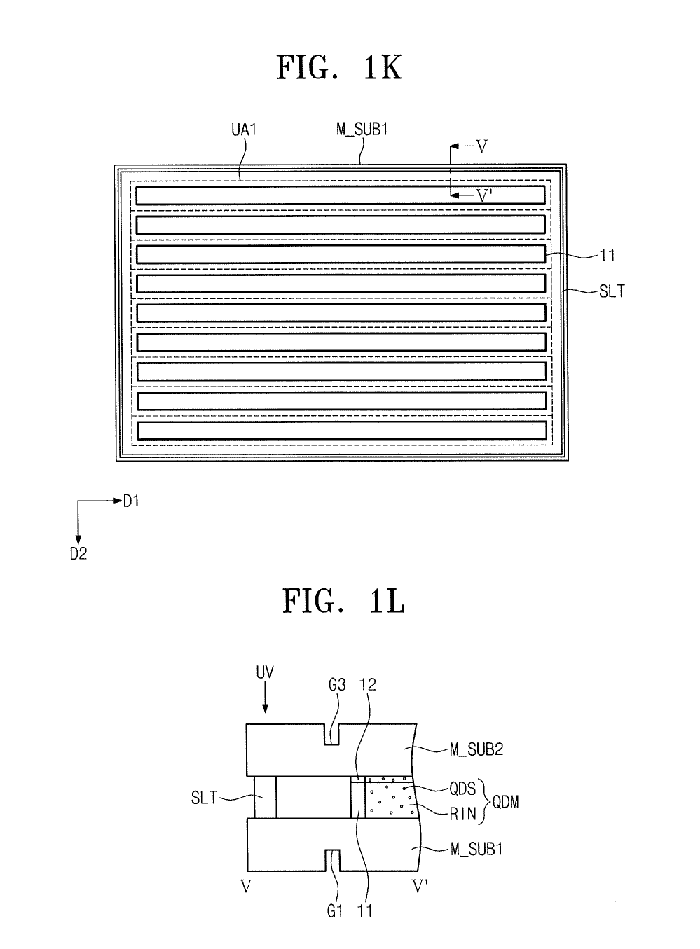

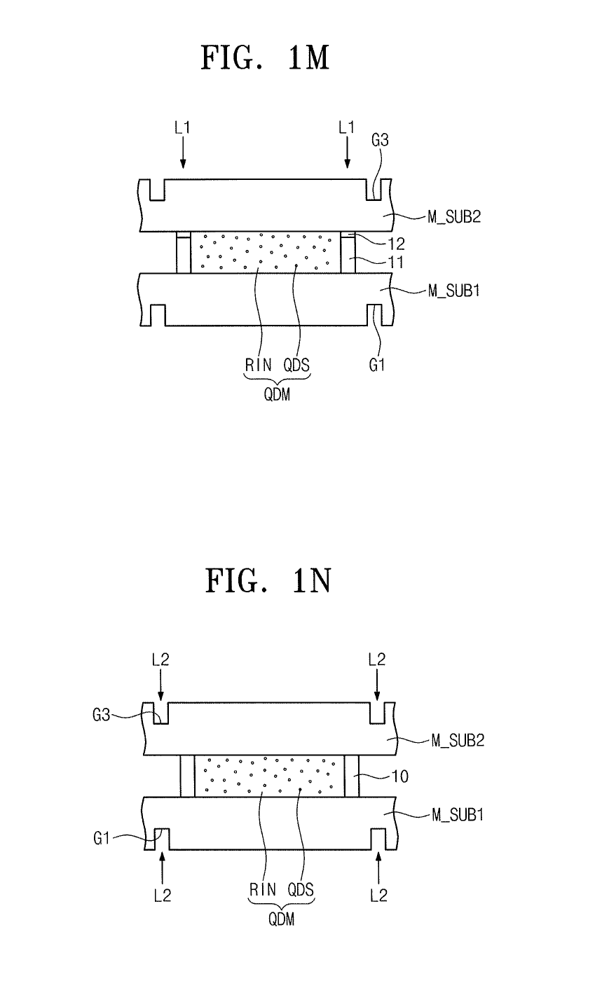

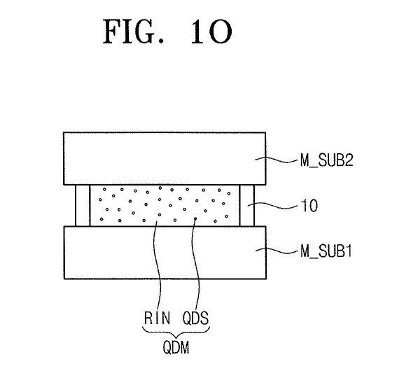

FIGS. 1A to 1O illustrate views of a method of manufacturing a light conversion member according to an exemplary embodiment.

FIG. 1A illustrates a view of a lower surface of a first mother substrate used to manufacture the light conversion member. Referring to FIG. 1A, the first mother substrate M_SUB1 may be prepared. The first mother substrate M_SUB1 may be formed of a light transmissive material. For example, the first mother substrate M_SUB1 may be formed of a glass material. The first mother substrate M_SUB1 may _{—} M_{—} SUB long sides in a first direction D1 and short sides in a second direction D2 substantially vertical to the first direction D1.

A plurality of first grooves G1 extending in the first direction D1 and a plurality of second grooves G2 extending in the second direction D2 may be formed on the lower surface of the first mother substrate M_SUB 1.

The first grooves G1 may be arranged in the second direction D2 at regular intervals. The second grooves G2 may be respectively disposed adjacent to both ends in the first direction D1 of the first mother substrate M _SUB1. For example, the number of the second grooves G2 may be two, one second groove G2 may be disposed adjacent to a left end of the first mother substrate M_SUB1 in the first direction D1, and the other second groove G2 may be disposed adjacent to a right end of the first mother substrate M_SUB1 in the first direction D1.

Areas defined by the first grooves G1 and the second grooves G2 will be referred to as first unit areas UA1. As an example, FIG. 1A illustrates nine first unit areas UA1 defined by the first grooves G1 and the second grooves G2.

Each first unit area UA1 may have long sides in the first direction D1 and short sides in the second direction D2.

FIG. 1B illustrates a cross-sectional view taken along a line I-I′ shown in FIG. 1A. Referring to FIG. 1B, the first grooves G1 may be formed by etching the lower surface of the first mother substrate M_SUB1 to have a predetermined depth. For example, the first grooves G1 may be formed by etching the first mother substrate M_SUB1 using hydrofluoric acid. Although not shown in a cross section, the second grooves G2 may be formed by etching the lower surface of the first mother substrate M_{—} SUB1 and may have the same depth as that of the first grooves G1.

Hereinafter, a thickness may be defined by a width between upper and lower surfaces of each element.

The first mother substrate M_SUB1 may have a thickness of about 0.5 mm. The first and second grooves G1 and G2 may have a depth of about 200 micrometers. The first grooves G1 may have the same width as that of the second grooves G2.

FIG. 1C illustrates a plan view of an upper surface of a second mother substrate M_SUB2 used to manufacture the light conversion member. Referring to FIG. 1C, the second mother substrate M_SUB2 may be prepared. The second mother substrate M_SUB2 may include the same material as that of the first mother substrate M_SUB1 and may have the same size as that of the first mother substrate M_SUB1. A plurality of third grooves G3 extending in the first direction D1 and a plurality of fourth grooves G4 extending in the second direction D2 may be formed on the upper surface of the second mother substrate M_SUB1.

The third grooves G3 may be arranged to respectively correspond to the first grooves G1 and the fourth grooves G4 may be arranged to respectively correspond to the second grooves G2. The first and second mother substrates M_SUB 1 and M_SUB2 may be disposed to overlap with each other, and the third grooves G3 may overlap the first grooves G1 and the fourth grooves G4 may overlap the second grooves G2.

Areas defined by the third grooves G3 and the fourth grooves G4 will be referred to as second unit areas UA2. The second unit areas UA2 may have the same shape as that of the first unit areas UA1.

FIG. 1D illustrates a cross-sectional view taken along a line II-II′ shown in FIG. 1C. Referring to FIG. 1D, the third grooves G3 may be formed by etching the upper surface of the second mother substrate M_SUB2 to have a predetermined depth. The third and fourth grooves G3 and G4 may be formed in the same method as that of the first and second grooves G1 and G2 and may have the same depth as that of the first and second grooves G1 and G2. The third and fourth grooves G3 and G4 may have a depth of about 200 micrometers. The third and fourth grooves G3 and G4 may have the same width as that of the first and second grooves G1 and G3.

FIG. 1E illustrates a view of an upper surface of the first mother substrate M_SUB1. Referring to FIG. 1E, first quantum-dot accommodating members 11 may be formed on the upper surface of the first mother substrate M_SUB1. Each of the first quantum-dot accommodating members 11 may have a rectangular closed-loop shape with long sides extending in the first direction D1 and short sides extending in the second direction D2.

Each of the first quantum-dot accommodating members 11 may be disposed in a corresponding first unit area of the first unit areas UA1. FIG. 1E illustrates nine first quantum-dot accommodating members 11 since the number of the first unit areas UA1 shown in FIG. 1A is nine.

The first quantum-dot accommodating members 11 may be formed by applying a frit paste on the upper surface of the first mother substrate M_SUB1. The frit paste may be applied on the upper surface of the first mother substrate M_SUB1 in the first unit areas UA1 along the rectangular closed-loop shape.

The frit paste may include frit powder particles, binder particles interposed between the frit powder particles, filler particles interposed between the frit powder particles, and a solvent that dissolves the frit powder particles, the binder particles, and the filler particles.

The frit paste may be dried at a first temperature, and the solvent may be removed. The frit paste, from which the solvent has been removed, may be sintered at a second temperature higher than the first temperature, and the binder particles may be removed.

The first temperature may be about 200 degrees Celsius and the second temperature may be from about 500 degrees Celsius to about 600 degrees Celsius. The frit paste may be dried at the first temperature and sintered at the second temperature, the fit powder particles may be densely bonded to each other by the filler particles, and a frit glass may be formed. The frit glass may be coupled to the first mother substrate M_SUB1 during the sintering process. The first quantum-dot accommodating members 11 may be formed using the frit glass.

FIG. 1F illustrates a cross-sectional view taken along a line III-III′ shown in FIG. 1E. Referring to FIG. 1F, the first quantum-dot accommodating members 11 may be formed on the upper surface of the first mother substrate M_SUB 1 at a first thickness of about 300 micrometers to about 350 micrometers. The first quantum-dot accommodating members 11 may be formed on the upper surface of the first mother substrate M_SUB1 by using a screen printing method.

FIG. 1G illustrates a view of a lower surface of the second mother substrate M_SUB2. Referring to FIG. 1G, second quantum-dot accommodating members 12 may be formed on the lower surface of the second mother substrate M_SUB2. Each of the second quantum-dot accommodating members 12 may be disposed in a corresponding second unit area of the second unit areas UA2. The second quantum-dot accommodating members 12 may be formed through the same process as that of the first quantum-dot accommodating member 11 and may include the same material as that of the first quantum-dot accommodating members 11.

The second quantum-dot accommodating members 12 may include the filler particles smaller in amount than those of the first quantum-dot accommodating members 11. As the amount of the filler particles increases, melting point, durability, and coupling force of the frit glass may become high.

The melting point, the durability, and the coupling force of the first quantum-dot accommodating members 11 may be higher than those of the second quantum-dot accommodating members 12, and the coupling force of the first quantum-dot accommodating members 11 bonded to the first mother substrate M_SUB 1 may be higher than the coupling force of the second quantum-dot accommodating members 12 bonded to the second mother substrate M_SUB2.

The second quantum-dot accommodating members 12 may have the same shape as that of the first quantum-dot accommodating members 11. The second quantum-dot accommodating members 12 may be formed to have the same width as that of the first quantum-dot accommodating members 11.

The second quantum-dot accommodating members 12 may be disposed to respectively correspond to the first quantum-dot accommodating members 11. The first and second mother substrates M_SUB1 and M_SUB2 may be disposed to overlap with each other, and the second quantum-dot accommodating members 12 may respectively overlap the first quantum-dot accommodating members 11.

FIG. 1H illustrates a cross-sectional view taken along a line IV-IV′ shown in FIG. 1G. Referring to FIG. 1H, the second quantum-dot accommodating members 12 may be formed on the lower surface of the second mother substrate M_SUB2 at a second thickness T2. The second thickness T2 may be smaller than the first thickness T1. In an exemplary embodiment, the second thickness T2 may be in a range from about 10 micrometers to about 15 micrometers.

FIGS. 1I and 1J illustrate views of a method of forming the quantum-dot accommodating member.

For the convenience of explanation, FIG. 1I illustrates a cross-sectional view corresponding to the cross section taken along the line III-III′, FIG. 1J illustrates a cross-sectional view corresponding to the cross section taken along the line IV-IV′, and the second mother substrate M_SUB2 is upside down. Referring to FIGS. 1I and 1J, a quantum dot resin may be filled in the first and second quantum-dot accommodating members 11 and 12 each having the rectangular closed-loop shape. The quantum dot resin may include a resin RIN and quantum dots QDS distributed in the resin RIN.

The quantum dot resin may be filled in the first and second quantum-dot accommodating members 11 and 12 at the same height as the upper surfaces of the first and second quantum-dot accommodating members 11 and 12. The quantum dot resin may be cured by an ultraviolet ray UV, and a quantum dot member QDM may be formed. The quantum dot member QDM may be formed such that an upper surface thereof may be disposed at the same height as the upper surface of the first quantum-dot accommodating member 11.

The quantum dot member QDM may be formed in the second quantum-dot accommodating members 12 after the second mother substrate M_SUB2 is upside down, the second mother substrate M_SUB2 may return to its original position, and the lower surface of the quantum dot member QDM formed in the second quantum-dot accommodating members 12 may be disposed at a position to correspond to the lower surface of the second quantum-dot accommodating members 12.

FIG. 1K illustrates a plan view of a sealant SLT disposed on the upper surface of the first mother substrate M_SUB1. Referring to FIG. 1K, the sealant SLT may be formed on the first mother substrate M_SUB 1 in the vicinity of a border of the first mother substrate M_SUB1. The sealant SLT may be disposed to surround the first unit areas UA1.

FIG. 1L illustrates a cross-sectional view taken along a line V-V′ shown in FIG. 1K of the first and second mother substrates M_SUB1 and M_SUB2 coupled to each other. Referring to FIG. 1L, the first and second mother substrates M_SUB1 and M_SUB2 may be disposed such that the upper surface of the first mother substrate M_SUB1 faces the lower surface of the second mother substrate M_SUB2. The first and second mother substrates M_SUB1 and M_SUB2 may be coupled to each other by the sealant SLT. The sealant SLT may be cured by the ultraviolet ray UV.

The first mother substrate M_SUB1 may be disposed to entirely overlap with the second mother substrate M_SUB2 and coupled with the second mother substrate M_SUB2 by the sealant SLT.

The first grooves G1 may be disposed to overlap with the third grooves G3. The first quantum-dot accommodating members 11 may be disposed to overlap with the second quantum-dot accommodating members 12. Although not shown in figures, the second grooves G2 may be disposed to overlap with the fourth grooves G4.

For the convenience of explanation, hereinafter, a boundary surface between the quantum dot member QDM filled in the first quantum-dot accommodating members 11 and the quantum dot member QDM filled in the second quantum-dot accommodating members 12 will be omitted. For the convenience of explanation, the cross sections of the first and second mother substrates M_SUB1 and M_SUB2 respectively corresponding to the lines III-III′ and IV-IV′ will de described.

FIG. 1M illustrates a cross-sectional view of a connection between the first and second quantum-dot accommodating members 11 and 12. Referring to FIG. 1M, a first laser beam L1 may be irradiated to the second quantum-dot accommodating members 12 from above the upper surface of the second mother substrate M_SUB2. The first laser beam L1 may be an infrared laser.

The first laser beam L1 may have enough energy to melt the second quantum-dot accommodating member 12. The first laser beam L1 may increase the temperature of the second quantum-dot accommodating member 12 until the second quantum-dot accommodating member 12 is melted. The first laser beam L1 may have a wavelength of about 770 nm. The first laser beam L1 may have a power of about 5 watts to about 8 watts.

The first laser beam L1 may be irradiated to the second quantum-dot accommodating member 12, and the second quantum-dot accommodating member 12 may be cured to be coupled to the first quantum-dot accommodating member 11. The second quantum-dot accommodating member 12 may be instantaneously melted by the first laser beam L1, and then coupled to the first quantum-dot accommodating member 11 while being gradually cured.

The second quantum-dot accommodating member 12 may be more strongly coupled to the second mother substrate M_SUB2 after being cured. During the sintering process, the coupling force between the second quantum-dot accommodating member 12 and the second mother substrate M_SUB2 may be smaller than the coupling force between the first quantum-dot accommodating member 11 and the first mother substrate M_SUB1. The second quantum-dot accommodating member 12 may be cured by the laser beam L1, and the coupling force of the second quantum-dot accommodating member 12 with respect to the second mother substrate M_SUB2 may become strong.

The first quantum-dot accommodating member 11 may have a melting point higher than that of the second quantum-dot accommodating member 12, and the first quantum-dot accommodating member 11 may not be cured even though the first laser beam L1 is applied to the first quantum-dot accommodating member 11.

As the thickness of the second quantum-dot accommodating member 12 becomes smaller, the power of the first laser beam L1 used to cure the second quantum-dot accommodating member 12 may be reduced. The second quantum-dot accommodating member 12 may be required to have a minimum predetermined thickness since the quantum dot member QDM may be formed in the second quantum-dot accommodating member 12.

The second quantum-dot accommodating member 12 may have durability weaker than that of the first quantum-dot accommodating member 11. The second quantum-dot accommodating member 12 may be cured, and a crack may occur in the second quantum-dot accommodating member 12 as the thickness of the second quantum-dot accommodating member 12 increases.

The thickness of the second quantum-dot accommodating member 12 may be determined by taking into consideration lowering of the power of the first laser beam L1, forming of the quantum dot member QDM, and prevention of a crack. In an exemplary embodiment, the second quantum-dot accommodating member 12 may have a thickness T2 of about 10 micrometers to about 15 micrometers.

The first and second quantum-dot accommodating members 11 and 12 may be coupled to each other to form the quantum-dot accommodating members 10.

FIG. 1N illustrates a cross-sectional view of a cutting process of the first and second mother substrates M_SUB1 and M_SUB2. Referring to FIG. 1N, a second laser beam L2 may be irradiated to the first grooves G1 of the first mother substrate M_SUB1. Although not shown in figures, the second laser beam L2 may be irradiated to the second grooves G2. The second laser beam L2 may be from a carbon dioxide (CO₂) laser. The first mother substrate M_SUB1 may be cut along the first and second grooves G1 and G2 to which the second laser beam L2 may be irradiated.

The second laser beam L2 may be irradiated to the third and fourth grooves G3 and G4 of the second mother substrate M_SUB2, and the second mother substrate M_SUB2 may be cut along the third and fourth grooves G3 and G4. The first and second mother substrates M _SUB1 and M_SUB2 may be sequentially or simultaneously cut.

The first and second mother substrates M_SUB1 and M_SUB2 may be cut along the first to fourth grooves G1 to G4, and light conversion members may be formed in the first and second unit areas UA1 and UA2.

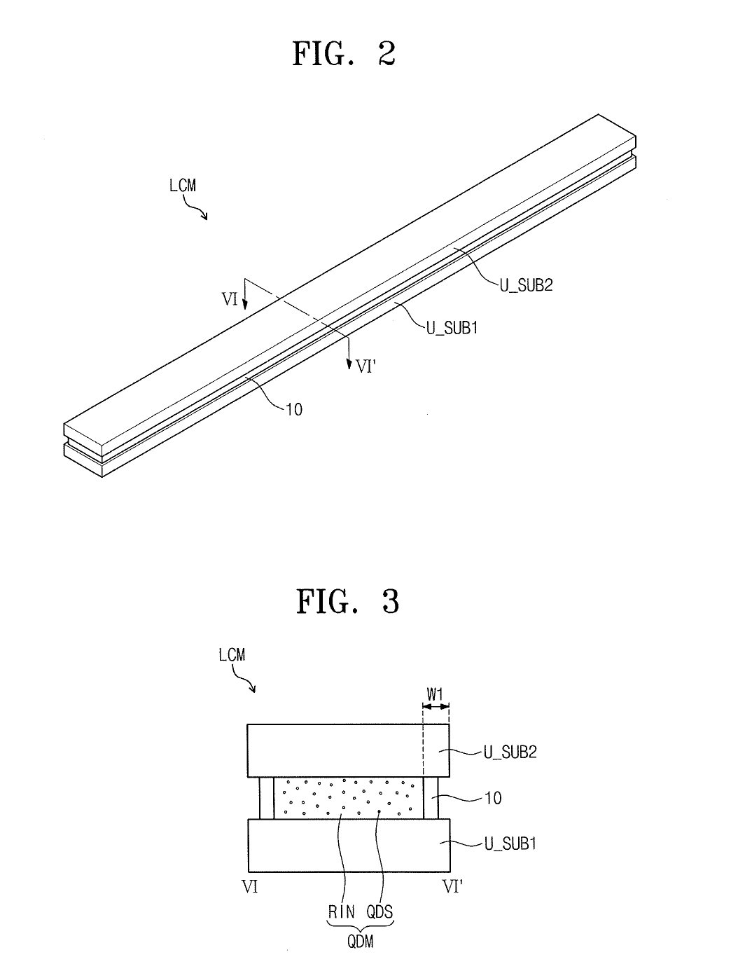

FIG. 1O illustrates a view of the light conversion member formed by cutting the first and second mother substrates. Referring to FIG. 1O, the first and second mother substrates M_SUB1 and M_SUB2 may be separated, e.g., cut, along the first to fourth grooves G1 to G4 and the light conversion members LCM may be formed. The light conversion members LCM will be described in detail with reference to FIGS. 2 and 3.

FIG. 2 illustrates a perspective view of the light conversion member manufactured by a manufacturing method according to an exemplary embodiment and FIG. 3 illustrates a cross-sectional view taken along line VI-VP shown in FIG. 2. Referring to FIGS. 2 and 3, the light conversion member LCM extends in a direction and may have a bar shape. The first and second mother substrates M_SUB1 and M_SUB2 of the light conversion member formed by the above-mentioned method are respectively referred to as first and second unit substrates U_SUB1 and U_SUB2.

The light conversion member LCM may include the first unit substrate U_SUB1, the second unit substrate U_SUB2, the quantum dot member QDM, and the quantum-dot accommodating member 10. The first and second unit substrates U_SUB1 and U_SUB2 may be formed of glass. The quantum-dot accommodating member 10 may include the frit glass formed by drying and sintering the frit paste.

The first and second unit substrates U_SUB 1 and U_SUB2 may be spaced apart from each other and disposed to face each other. The quantum dot member QDM may be disposed between the first unit substrate U_SUB1 and U_SUB2.

The quantum-dot accommodating member 10 may be provided between the first and second unit substrates U_SUB1 and U_SUB2 and disposed adjacent to the boundary of the first and second unit substrates U_SUB1 and U_SUB2. The quantum-dot accommodating member 10 may have a thickness of about 310 micrometers to about 365 micrometers.

The quantum-dot accommodating member 10 may seal the space between the first and second unit substrates U_SUB1 and U_SUB2. The quantum dot member QDM may be disposed between the first and second unit substrates U_SUB1 and U_SUB2 and accommodated in the space sealed by the quantum-dot accommodating member 10.

The quantum dot member QDM may include the resin RIN and the quantum dots QDS distributed in the resin RIN. The quantum dot member QDM may convert a first light incident thereto to a second light. For example, the quantum dot member QDM may convert light provided from the backlight unit supplied to the display apparatus to a white light. The first light may be a blue light.

The quantum dot member QDM may include different-sized quantum dots in accordance with the kind of light source to emit white light. For example, the light source may emit blue light, and the quantum dot member QDM may include quantum dots QDS having a size appropriate to absorb blue light and emit green light and/or red light.

The quantum dots QDS of the quantum dot member QDM may absorb blue light from the light source and may convert the blue light to green or red light. A portion of the blue light may not be absorbed by the quantum dots QDS, and the lights having blue, green, and red wavelengths may be mixed to each other in the quantum dot member QDM, such that white light may be generated. In other words, two or more sizes of quantum dots QDS may be provided in the quantum dot member QDM.

An area between an inner surface of the quantum-dot accommodating member 10 disposed adjacent to the quantum dot member QDM and the side surface of each of the first and second unit substrates M_SUB1 and M_SUB2 is referred to as a boundary area BA. The boundary area BA may have a first width W1.

Although not shown in figures, a boundary area of the light conversion member LCM may have a first width W1 in the extension direction of the light conversion member LCM. The first width W1 may be equal to or smaller than about 1.5 mm. The first and second unit substrates U_SUB1 and U_SUB2 may include the glass and each of the first and second unit substrates U_SUB1 and U_SUB2 may have a thickness of about 0.5 mm.

The first width W1 of the boundary area BA in the extension direction of the light conversion member LCM may be smaller than a length of one end of a tube in a conventional light conversion member, and a narrow bezel of the display apparatus may be realized even though the display apparatus employs the light conversion member LCM.

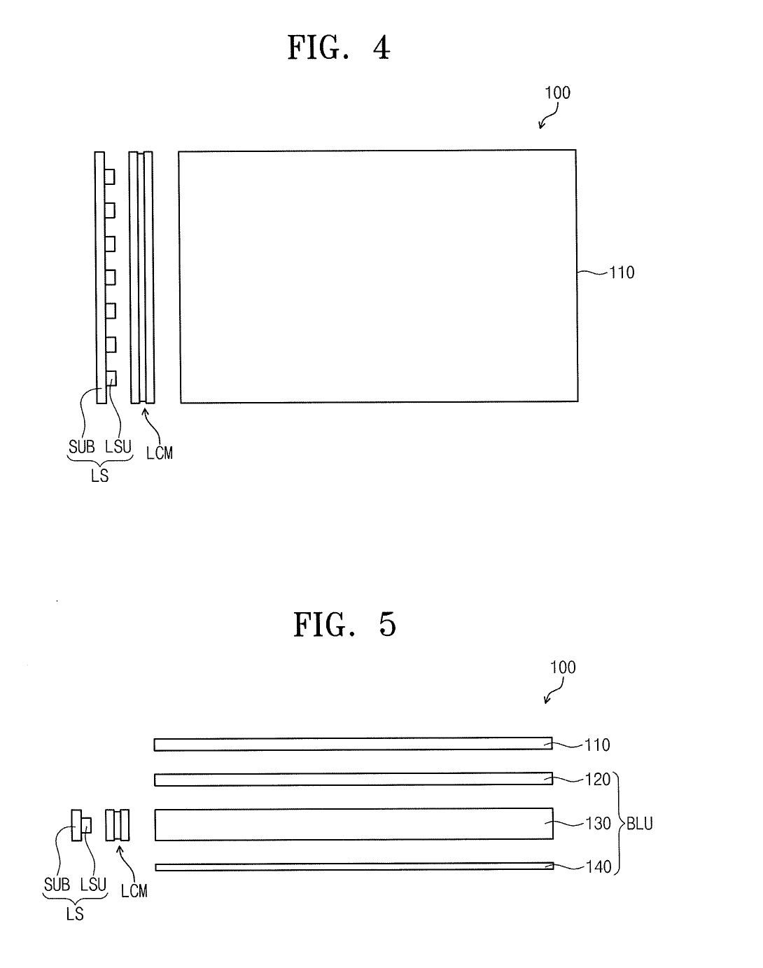

FIG. 4 illustrates an upper plan view of a display apparatus employing a light conversion member according to an exemplary embodiment and FIG. 5 illustrates a side view of a display apparatus employing a light conversion member according to an exemplary embodiment. Referring to FIGS. 4 and 5, the display apparatus 100 may include a display panel 110 that displays an image using a light and a backlight unit BLU that generates and supplies the light to the display panel 110.

The display panel 110 may be, for example, a liquid crystal display panel including a liquid crystal layer. Although not shown in figures, the display panel 110 may include a plurality of pixels displaying the image using the light.

The backlight unit BLU may be an edge-illumination type backlight unit. The light generated by the backlight unit BLU may be white light.

The backlight unit BLU may include a light source LS, the light conversion member LCM, an optical sheet 120, a light guide plate 130, and a reflection plate 140.

The light source LS may be adjacent to one side of the light guide plate 130. The light conversion member LCM may be between the light source LS and one side of the light guide plate 130. The reflection plate 140 may be under the light guide plate 130 and the optical sheet 120 may be on the light guide plate 130. The display panel 110 may be on the optical sheet 120.

The light source SL may include a substrate SUB and a plurality of light source units LSU mounted on the substrate SUB. The light source units LSU may be, for example, blue light emitting diodes to generate blue light.

The light source units LSU of the light source LS may generate blue light and supply blue light to the light conversion member LCM. The light conversion member LCM may convert blue light to white light, i.e., convert some blue light into red light, convert some blue light into green light, and transmit some blue light, and supply white light to the light guide plate 130.

The light guide plate 130 may change a path of the light incident through one side thereof such that the light travels upward toward the display panel 110 on the light guide plate 130. The reflection plate 140 may reflect the light leaking downward from the light guide plate 130, and the reflected light may be allowed to travel to the display panel 110.

The optical sheet 120 may include a diffusion sheet (not shown) and a prism sheet (not shown) disposed on the diffusion sheet. The diffusion sheet may diffuse the light provided from the light guide plate 120.

The prism sheet may condense the light diffused by the diffusion sheet, and the condensed light may be allowed to travel in an upper direction substantially vertical to the flat surface of the light guide plate 130. The light exiting from the prism sheet may travel in the upper direction substantially vertical to the flat surface and may be supplied to the display panel 110 with uniform brightness distribution.

The display apparatus 100 may include the light conversion member LCM provided with the boundary area BA having the first width, and a narrow bezel may be realized.

By way of summation and review, a light conversion member including quantum dots may be used to improve the efficiency of light supplied to a display panel. The light conversion member may have a bar shape and may be applied to an edge-illumination type backlight unit. The light conversion member may convert a blue light to a white light.

A tube, in which an inner space extending in one direction is defined, may be used to manufacture the light conversion member having the bar shape. The tube may be formed of glass. One end in the extending direction of the tube may be opened and the other end in the extending direction of the tube may be closed. A quantum dot resin may be filled in the inner space of the tube through the one end of the tube and cured. Then, the one end of the tube may be sealed by a sealing member, and the light conversion member may be manufactured.

The other end of the tube may be integrally formed with the tube and may have a thickness greater than that of the one end of the tube. For example, the other end of the tube may have a length of about 10 mm in the extending direction, and it may be difficult to realize a narrow bezel in the display apparatus employing the light conversion member with the bar shape.

Provided is a light conversion member for a display apparatus having a narrow bezel. Provided is a display apparatus having the light conversion member. Provided is a method of manufacturing the light conversion member.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A method of manufacturing a light conversion member, the method comprising:
forming a plurality of first grooves extending in a first direction on a lower surface of a first mother substrate and a plurality of second grooves extending in a second direction orthogonal to the first direction on the lower surface of the first mother substrate;
forming a plurality of third grooves extending in the first direction on an upper surface of a second mother substrate and a plurality of fourth grooves extending in the second direction on the upper surface of the second mother substrate;
forming first quantum-dot accommodating members on an upper surface of the first mother substrate to have a rectangular closed-loop shape, the first quantum-dot accommodating members being in first unit areas defined by the first and second grooves;
forming second quantum-dot accommodating members on a lower surface of the second mother substrate to have a rectangular closed-loop shape, the second quantum-dot accommodating members being in second unit areas defined by the third and fourth grooves;
forming a quantum dot member in the first and second quantum-dot accommodating members;
coupling the first mother substrate and the second mother substrate such that the upper surface of the first mother substrate faces the lower surface of the second mother substrate;
connecting the first and second quantum-dot accommodating members; and
separating the first and second mother substrates along the first to fourth grooves to form light conversion members.

2. The method as claimed in claim 1, wherein the first and third grooves are arranged in the second direction at regular intervals, the second grooves are adjacent to both ends of the first mother substrate in the first direction, and the fourth grooves are adjacent to both ends of the second mother substrate in the first direction.

3. The method as claimed in claim 1, wherein each of the first and second mother substrates has a thickness of about 0.5 mm and the first to fourth grooves have a same width and a depth of about 200 micrometers.

4. The method as claimed in claim 1, wherein the first and second mother substrates include glass, the first and second quantum-dot accommodating members include a fit glass, and forming the first and second quantum-dot accommodating members includes drying and sintering a fit paste.

5. The method as claimed in claim 4, wherein the first quantum-dot accommodating members have a melting point, a durability, and a coupling force, which are respectively higher than a melting point, a durability, and a coupling force of the second quantum-dot accommodating members.

6. The method as claimed in claim 1, wherein the first and second quantum-dot accommodating members have a same width, the first quantum-dot accommodating members have a first thickness, and the second quantum-dot accommodating members have a second thickness smaller than the first thickness.

7. The method as claimed in claim 6, wherein the first thickness is in a range from about 300 micrometers to about 350 micrometers and the second thickness is in a range from about 10 micrometers to about 15 micrometers.

8. The method as claimed in claim 1, wherein forming the quantum dot member includes:
filling the first and second quantum-dot accommodating members with a quantum dot resin including a resin and quantum dots distributed in the resin; and
curing the quantum dot resin to form the quantum dot member, the quantum dot member having a height corresponding to an upper surface of the first quantum-dot accommodating members and a lower surface of the second quantum-dot accommodating members.

9. The method as claimed in claim 1, wherein coupling the first and second mother substrates includes:
disposing a sealant on the upper surface of the first mother substrate to surround the first unit areas; and
coupling the first and second mother substrates using the sealant after disposing the first and second mother substrates such that the upper surface of the first mother substrate faces the lower surface of the second mother substrate, the first grooves overlap with the third grooves, the second grooves overlap with the fourth grooves, and the first quantum-dot accommodating members overlap with the second quantum-dot accommodating members.

10. The method as claimed in claim 1, wherein connecting the first and second quantum-dot accommodating members includes irradiating the second quantum-dot accommodating members from above the upper surface of the second substrate to connect the second quantum-dot accommodating members and the first quantum-dot accommodating members, and the second quantum-dot accommodating members are cured by irradiating.

11. The method as claimed in claim 10, wherein irradiating is performed using a laser beam having a wavelength of about 770 nm and a power of about 5 W to about 8 W.

12. The method as claimed in claim 1, wherein forming the light conversion members includes irradiating the first to fourth grooves to cut the first and second mother substrates along the first to fourth grooves.

13. The method as claimed in claim 12, wherein irradiating is performed using a laser beam output from a CO₂ laser.

14. The method as claimed in claim 1, wherein a width between an inner surface of each of the first and second quantum-dot accommodating members adjacent to the quantum dot member and each side surface of first and second unit substrates formed by cutting the first and second mother substrates is equal to or smaller than about 1.5 mm.

15. A light conversion member, comprising:
a first unit substrate;
a second unit substrate facing the first unit substrate;
a quantum-dot accommodating member between the first and second unit substrates and adjacent to a boundary of the first and second unit substrates, the quantum-dot accommodating member forming a sealed space between the first and second unit substrates; and
a quantum dot member in the sealed space, the quantum dot member converting light incident thereon to white light.

16. The light conversion member as claimed in claim 15, wherein the first and second unit substrates each includes glass and the quantum-dot accommodating member includes a frit glass.

17. The light conversion member as claimed in claim 15, wherein each of the first and second unit substrates has a thickness of about 0.5 mm and the quantum-dot accommodating member has a thickness of about 310 micrometers to about 365 micrometers.

18. The light conversion member as claimed in claim 15, wherein a width between an inner surface of the quantum-dot accommodating member adjacent to the quantum dot member and each side surface of the first and second unit substrates is equal to or smaller than about 1.5 mm.

19. A display apparatus, comprising:
a display panel;
a light source that generates a first light;
a light conversion member that converts the first light to a second light;
a light guide plate that guides the second light towards the display panel;
an optical sheet that receives the second light from the light guide plate, the optical sheet diffusing and condensing the second light towards the display panel; and
the display panel displaying an image using the second light,
the light source being adjacent to one side of the light guide plate, the light conversion member being between the light source and the light guide plate, the light conversion member including:
a first unit substrate;
a second unit substrate facing the first unit substrate;
a quantum-dot accommodating member between the first and second unit substrates and adjacent to a boundary of the first and second unit substrates, the quantum-dot accommodating member forming a sealed space between the first and second unit substrates; and
a quantum dot member in the sealed space, the quantum dot member converting light incident thereon to white light, the first and second unit substrates including glass, and the quantum-dot accommodating member including a frit glass.

20. The display apparatus as claimed in claim 19, wherein each of the first and second unit substrates has a thickness of about 0.5 mm, the quantum-dot accommodating member has a thickness of about 310 micrometers to about 365 micrometers, and a width between an inner surface of the quantum-dot accommodating member adjacent to the quantum dot member and each side surface of the first and second unit substrates is equal to or smaller than about 1.5 mm.
